(19) United States
(12) Patent Application Publication
(10) Pub. No.: US 2006/0030169 A1
(43) Pub. Date: Feb. 9, 2006

(54) Sheet type connector and method of manufacturing the same

(76) Inventors: Atsuhito Noda, Tokyo (JP); Shigeyuki Hoshikawa, Yamato-shi (JP)

Correspondence Address: MOLEX INCORPORATED, 2222 WELLINGTON COURT, LISLE, IL, 60532, US

(21) Appl. No.: 11/102,364

(22) Filed: Apr. 8, 2005

(30) Foreign Application Priority Data
Aug. 5, 2004 (JP) 2004-228751

(51) Int. Cl. H01R 12/00

(52) U.S. Cl. 439/66

(57) ABSTRACT

A sheet type connector has an insulation sheet and a plurality of conductive contacts provided on the sheet in an array of “M” rows and “N” columns. A plurality of conductive contacts are successively stamped and formed in a metal sheet and are disposed on a belt-like insulation sheet in an array of “m” rows and “n” columns to produce an intermediate sheet, where “m” is an integer greater than “M” and “n” is an integer greater than “N”. Thereafter, said intermediate sheet is cut into such size that the conductive contacts in “M” rows by “N” columns are included.

### BACKGROUND OF THE INVENTION

The present invention relates to a sheet-type connector for use in connection of CPUs or other type semi-conductors, and more particularly, to a sheet-type connector having a configuration so that its conductive contacts are arranged in an array of rows and columns with high density.

In the art, sheet-type connectors have been made by subjecting a metal sheet to etching and forming to produce a plurality of conductive contacts thereon in a matrix of rows and columns. Thereafter, the metal sheet is integrated with an square insulation sheet as shown in Japanese Patent No. 2620502 and Japanese Patent Laid-Open No. 2003/124404.

As described above, the sheet-type connectors of the prior art have been manufactured so that the conductive contacts corresponding to conductive parts of the CPU and other semi-conductor elements are produced by etching and forming the metal sheet. Every time a semi-conductor with different number of contact pads poles is manufactured, or the number of rows and columns in the matrix is changed, it becomes necessary to change the etching mask and the material. This makes the manufacturing of the connector extremely complicated.

The etching of the metal sheet may also restrict improvement in precision for shape and pitch of the conductive contacts, which makes it difficult to provide stable conductive contacts with higher density. The present invention is directed to a sheet connector that overcomes the aforementioned disadvantages.

### SUMMARY OF THE INVENTION

Accordingly, it is a general object of the present invention to provide a new configuration of a sheet that permits changing the number of pads in the conductive sections of the semi-conductor integrated circuit elements.

Another object of the present invention is to provide a sheet-type connector and method of making the same, which improves the precision of the shape and pitch of the contacts of the sheet connector.

A further object of the present invention is to provide method of manufacturing conductive contacts for a sheet type connector, which can improve in precision for shape and pitch of the conductive contacts.

To attain such objects the present invention provides, in one aspect thereof, a sheet type connector, comprising an insulation sheet and a plurality of conductive contacts provided on said insulation sheet in an array of “M” rows and “N” columns, with the contacts being successively stamped and formed in a metal sheet are disposed on a belt-like insulation sheet in an array of “m” rows and “n” columns to produce an intermediate sheet, where “m” is an integer greater than “M” and “n” is an integer greater than “N”, and thereafter, said intermediate sheet is cut into such size that the conductive contacts in “M” rows by “N” columns are included.

In this connection it is noted that “M” and “N” are integers of not less than one. However, the present invention is not applied to the case where “M”=“N”=1 which means that the number of poles is 1.

In another aspect, the present invention provides a method of manufacturing a sheet type connector, comprising an insulation sheet and a plurality of conductive contacts provided on said insulation sheet in an array of “M” rows and “N” columns, characterized in that it comprises the steps of: providing a belt-like metal sheet, and successively producing one or more columns of conductive contacts by a stamping and forming process in said metal sheet in the longitudinal direction thereof, said conductive contacts coupled to each other by carriers, said carriers including carriers at one or both sides of the metal sheet, side-carriers, and center carriers; providing a belt-like insulation sheet having carriers at one or both sides thereof and a plurality (“m”) of through-holes formed between said carriers at the predetermined interval in the column direction, where “m” is an integer greater than “M”, and separating the stamped and formed conductive contacts in a unit of “m” rows from the metal sheet, and thereafter, adhering that conductive contacts to the insulation sheet while registering the conductive contacts with the through-holes of the insulation sheet, respectively, to form an intermediate sheet;
removing the center carriers each still coupling the conductive contacts adhered to the insulation sheet; and cutting the intermediate sheet including the conductive contacts adhered to the insulation sheet into such size that the conductive contacts in “M” rows by “N” columns are included.

According to the present invention, as described above, the intermediate sheet having the conductive contacts in the array of “m” rows (“m” is greater than “M”) and “n” columns (“n” is greater than “N”) can be cut to produce the sheet type connector having desired configuration of the conductive contacts in the array of “M” rows and “N” columns. Therefore, it is possible to easily manufacture the sheet type connector having the conductive contacts configured to correspond to the conductive section of the semi-conductor integrated circuit element with which the present connector is mated.

Furthermore, there is no need to provide various kinds of molds each for molding the metal sheet for each of various kinds of semi-conductor integrated circuit elements. Instead, a common mold is used for all kinds of semi-conductor integrated circuit elements, which can realize extremely reasonable and economical manufacturing for the connector.

In addition, the metal sheet is successively stamped and formed to produce the conductive contacts, which makes possible to improve in precision for shape and pitch of the conductive contacts in order to meet the higher density requirement for the conductive contacts and to provide higher stability in connection for the conductive contacts, and thus, higher reliability in performance for the connector. In particular, even for the case where the conductive contacts become reduced in height with the progress of lower profile configuration of the connector the conductive contacts of the present invention can still maintain adequate contact pressure.

These and other objects, features and advantages of the present invention will be clearly understood through a consideration of the following detailed description.

### BRIEF DESCRIPTION OF THE DRAWINGS

In the course of this detailed description, the reference will be frequently made to the attached drawings in which:

FIG. 1 is a perspective view illustrating method of manufacturing a sheet type connector according to one embodiment of the present invention;

FIG. 2 is a plan view partially illustrating a metal sheet being stamped and formed according to the embodiment;

FIG. 3 is a cross section view illustrating raising of a coiled conductive portion of a conductive contact according to the embodiment;

FIG. 4 is a perspective view partially illustrating a metal sheet being stamped and formed according to the embodiment;

FIG. 5 is an enlarged view illustrating a sheet type connector cut out from an intermediate sheet according to the embodiment;

FIG. 6 is a concept view illustrating an example of usage of the sheet type connector according to the embodiment;

FIG. 7 is a concept view illustrating another example of usage of the sheet type connector according to the embodiment; and,

FIG. 8 is a concept view illustrating further example of usage of the sheet type connector according to the embodiment.

### DETAILED DESCRIPTION OF THE PREFERRED EMBODIMENTS

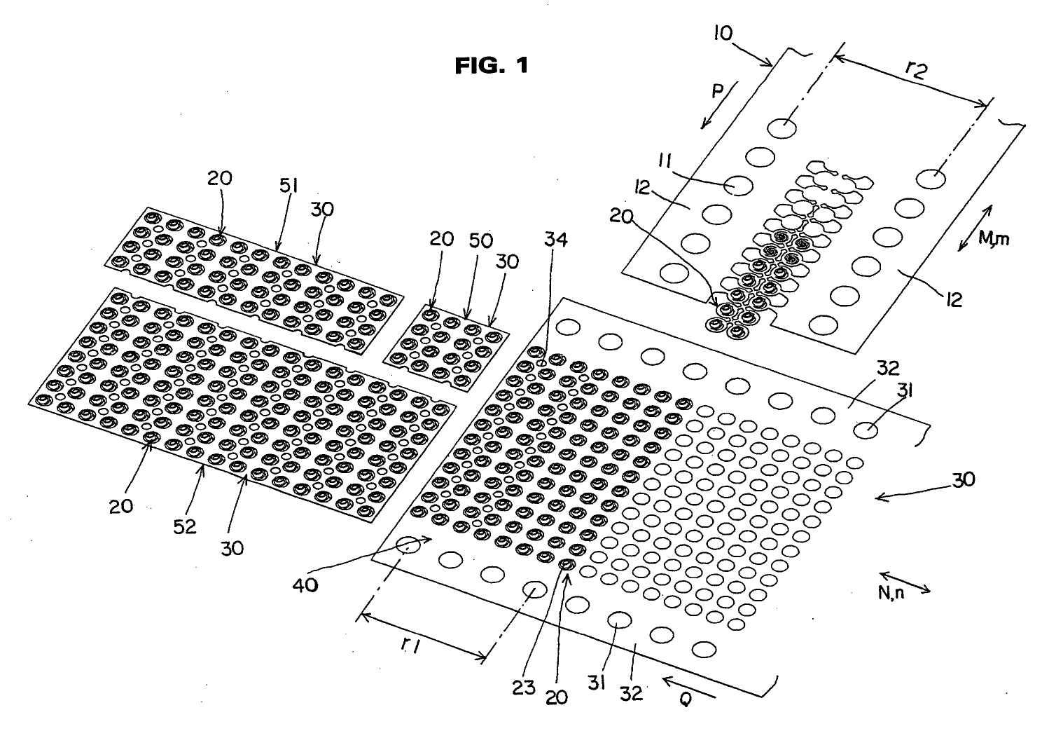

Referring to FIG. 1, a belt-like metal sheet 10 is processed by a stamping and forming process to successively produce a plurality of conductive contacts 20 which are then adhered to a belt-like insulation sheet 30 to produce an intermediate sheet 40. Then, the intermediate sheet 40 is cut to produce a plurality of sheet type connectors 50, 51 and 52 each having different number of poles. It is noted, here, that the direction of “rows” is defined as the longitudinal direction of the belt-like insulation sheet 30 in FIG. 1 so that the number of rows is counted in the direction indicated by a double headed arrow “M, m”. On the other hand, the direction of “columns” is defined as the longitudinal direction of the belt-like metal sheet 10 in FIG. 1 so that the number of columns is counted in the direction indicated by a double headed arrow “N, n”.

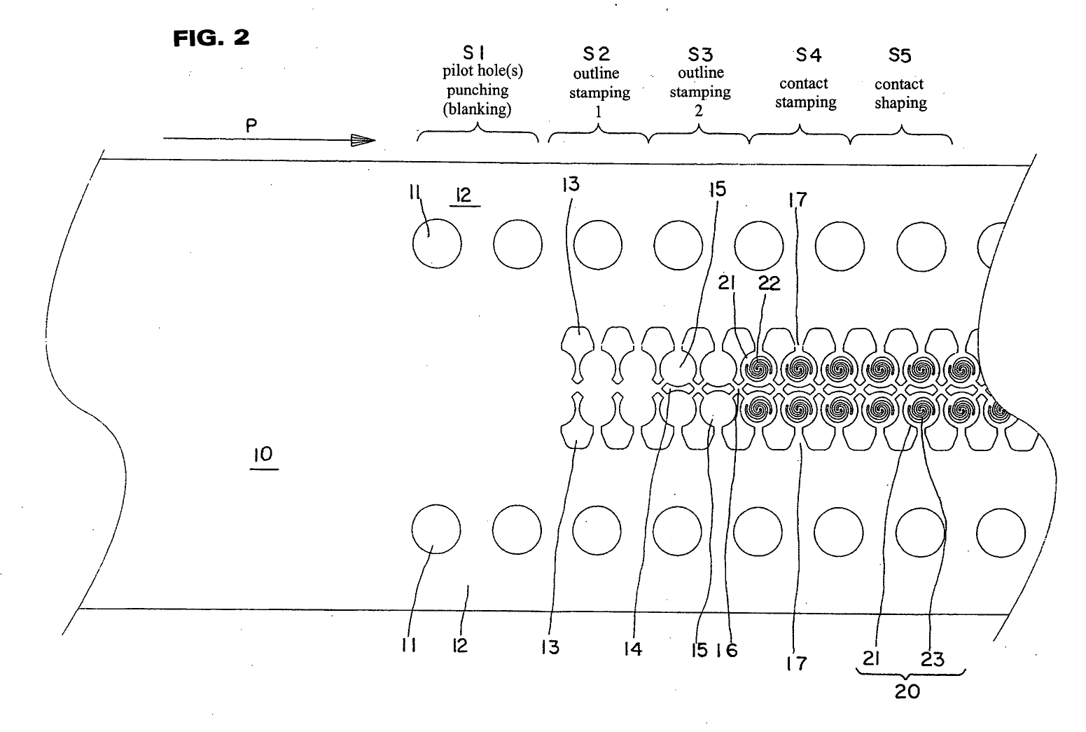

The process of producing the conductive contacts 20 by a stamping and forming process in the belt-like metal sheet 10 is performed in steps S1 to S5, as illustrated in FIG. 2. At step S1 pilot holes 11, 11 are provided in the metal sheet 10 at both sides thereof at the predetermined pitch to produce carriers 12, 12 at both sides of the metal sheet 10.

Then, at steps S2 and S3, the metal sheet 10 is stamped to remain such shape that corresponds to external shape of the conductive contacts 20 between the carriers 12, 12 of the metal sheet 10 which is intermittently feed in the direction indicated by an arrow “P” at the predetermined pitch with the aid of the pilot holes 11, 11. At step S2, i.e. in a first stamping for external shape of the conductive contacts 20, two columns of openings 13 in the form of a leaf of a gingko tree are formed with joints of the leaves faced to each other. At step S3, i.e. in a second stamping for external shape of the conductive contacts 20, openings 14 in the form of a balance weight are formed between the two columns of openings 13. As the result, two columns of generally circular contact-forming portions 15 are formed at the predetermined pitch. The two columns of contact-forming portions 15 are coupled to each other by center carriers 16 in the form of a cross remaining between the columns, and are coupled to the carriers 12 via side carriers 17 remaining outside the columns.

As seen in FIG. 2, the center carrier 16 is positioned at the center of four contact-forming portions 15 to diagonally extend to couple therebetween. Coupling between four contact-forming portions 15 by the center carrier 15 is repeated, as shown. In the above mentioned embodiment the pilot holes 1 1 are provided at both sides of the metal sheet 10 to produce two carriers 12. Alternatively, the pilot holes 11 may be provided only at one side of the metal sheet 10 to produce a single carrier 12. Furthermore, a plurality of columns of conductive contacts 20 may be provided at both sides of a single carrier 12. In addition, the metal sheet 10 may have no carrier 12 formed therein, but may have only either the side carriers 17 or the center carriers 16 formed therein.

After the first and second stamping for external shape of the conductive contacts 20, at step S4, a contact-stamping is performed in the contact-forming portion 15 to produce an annular conductive portion 21 and a pair of spiral conductive portions 22. Each of base ends of the spiral conductive portions 22 are formed to continue to the annular conductive portion 21. Then, at step S5, a contact-raising is performed to raise the spiral conductive portions 22 in the axial direction of the annular conductive portion 21 to form a coiled conductive portion 23. As the result, a conductive contact 20 including the annular conductive portion 21 and the coiled conductive portions 23 projected in the axial direction of the annular conductive portion 21 is completed.

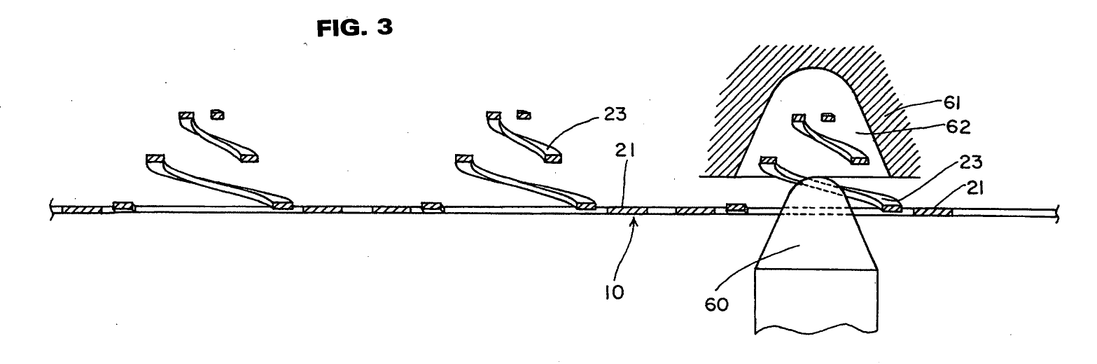

The raising of the spiral conductive portion 22 at step S5 is performed, as shown in FIG. 3. In particular, a punch 60 is provided at lower side of the metal sheet 10 and a die 61 is provided at upper side of the metal sheet 10. The die 61 is positioned to abut the upper surface of the metal sheet 10 and the punch 60 is pushed against a recess 62 of the die 61.

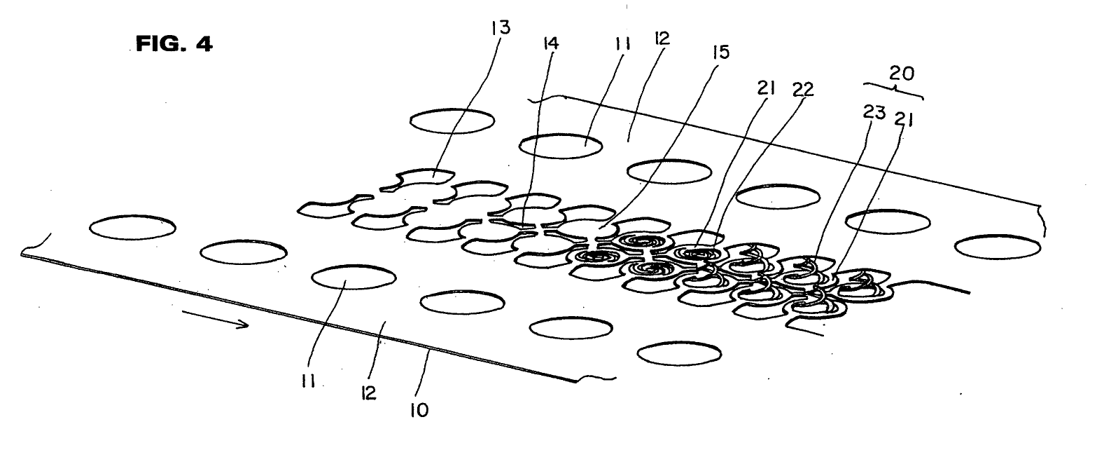

FIG. 4 illustrates the stamping and forming process for the conductive contacts as it is progressively performed on the metal sheet 10. In the embodiment as above the metal sheet 10 is a thin metal plate of phosphor bronze, but it may be a metal plate of beryllium copper or other spring material. Furthermore, the conductive contacts 20 are produced by the stamping and forming process in two columns along the longitudinal direction of the metal sheet 10, but they may be produced in single column or three or more columns. The annular conductive portion 21 of the conductive contact 20 is in the form of a circle, but it may be in the form of an oval or a polygon. In addition, a pair of coiled conductive portions 23 is provided, but single or three or more coiled conductive portions 23 may be provided.

The process of adhering the stamped and formed conductive contacts 20 to the belt-like insulation sheet 30 to produce the intermediate sheet 40 includes a step of separating two columns of the conductive contacts 20 in a unit of the predetermined number of rows from the metal sheet 10 and adhering them to the insulation sheet 30, and a step of removing the center carriers 16 by which the adhered conductive contacts 20 are coupled to each other.

The belt-like insulation sheet 30 is provided with an adhesive layer (not shown) at the lower side thereof in FIG. 1. In the same manner as the case of the metal sheet 10, pilot holes 31, 31 are provided in the insulation sheet 30 at both sides thereof at the predetermined pitch to produce carriers 32, 32 at both sides of the insulation sheet 30. Then, one or more columns of through-holes 33 are successively provided between the carriers 32, 32 of the insulation sheet 30 which is intermittently feed in the direction indicated by an arrow “Q” at the predetermined pitch with the aid of the pilot holes 31, 31. In this embodiment the distance “r1” spanning over four pilot holes 31 is equal to the distance “r2” between the pilot holes 11 at both sides of the metal sheet 10.

Furthermore, the spacing between columns of the through-holes 33 is equal to that of the conductive contacts 20 on the metal sheet 10, and the pitch of the through-holes 33 within a column is equal to that of the conductive contacts 20 within a column. Accordingly, it is possible to register the metal sheet 10 with the insulation sheet 30 with the aide of the pilot holes 11, 31 so that two columns of conductive contacts 20 separated from the metal sheet 10 coincides with the two columns of the through-holes 33 in the insulation sheet 30 with 1:1 relationship.

In this embodiment each of columns of the through-holes 33 in the insulation sheet 30 has 12 rows. Accordingly, separation of the conductive contacts 20 from the metal sheet 10 is performed with 12 rows. It is noted, here, that the number of rows (“m”) of the through-holes 33 in the insulation sheet 30 is determined depending on the number of rows (“M”) of the sheet type connector 50, 51, 52 that is finally manufactured. Therefore, “m” is an integer that is greater than the number of rows (“M”) of the sheet type connector 50, 51, 52. Separation of the conductive contacts 20 is performed by cutting the side carriers 17 coupling between the carriers 12 and the annular conductive portions 21 of the conductive contacts 20. The separated conductive contacts 20 in the array of 12 rows and 2 columns are still coupled to each other by the center carriers 16.

The separated and registered conductive contacts 20 in the array of 12 rows and 2 columns are then adhered to the bottom surface of the insulation sheet 30 (as viewed in FIG. 1) with the coiled conductive portions 23 faced upwardly. In particular, each conductive contact 20 is positioned in such manner that the upper surface of the annular conductive portion 21 is engaged to the bottom surface of the insulation sheet 30 and the coiled conductive portion 23 is projected to the upper side of the insulation sheet 30 via the through-hole 33.

Thereafter, the center carriers 16 still remaining on the insulation sheet 30 to which the conductive contacts 20 in the array of 12 rows and 2 columns are adhered are removed to produce an intermediate sheet 40. The process of removing the center carriers 16 is performed in such manner that the center carrier 16 itself and a portions of the insulation sheet 30 that is directly over the center carrier 16 are concurrently removed by a stamping process to produce a second through-hole 34. By removing the center carriers 16 the conductive contacts 20 are electrically separated from each other to form individual independent poles. Now, the intermediate sheet 40 having the conductive contacts 20 disposed in the array of 12 rows and “n” columns is prepared.

In this embodiment the insulation sheet 30 is formed from polyimide material, but it may be formed from other synthetic resin insulation material. Furthermore, as described above, the center carrier 16 is removed in such manner that the center carrier 16 itself and a portions of the insulation sheet 30 that is directly over the center carrier 16 are concurrently removed by a stamping process to produce a second through-hole 34. Alternatively, the second through-hole 34 may be provided in advance, e.g. at such time that the through-hole 33 is provided, and only the center carrier 16 may be removed by a stamping process via the second through-hole 34.

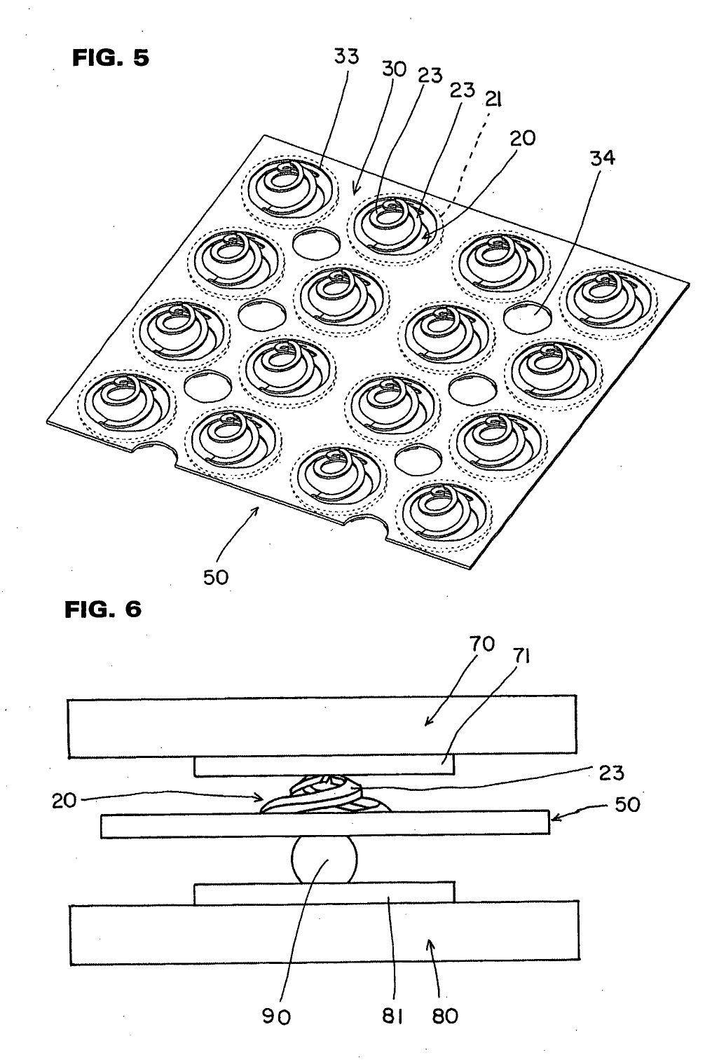

Then, the intermediate sheet 40 having the conductive contacts 20 disposed in the array of 12 rows and “n” columns is processed by arbitrary cutting the insulation sheet 30 to produce a sheet type connector having different number of poles or conductive contacts 20 (in an array of “M” rows and “N” columns). Referring to FIG. 1, three kinds of sheet type connectors are shown: a sheet type connector 50 produced by cutting an area of the intermediate sheet 40 including the conductive contacts 20 in 4 rows by 4 columns; a sheet type connector 51 produced by cutting an area of the intermediate sheet 40 including the conductive contacts 20 in 4 rows by 12 columns; and a sheet type connector 52 produced by cutting an area of the intermediate sheet 40 including the conductive contacts 20 in 8 rows by 16 columns. In particular, the sheet type connector 50 is shown enlarged in FIG. 5.

In this way, the sheet type connector having the conductive contacts 20 in “M” rows by “N” columns is produced by cutting the intermediate sheet 40 in which the conductive contacts 20 are adhered to the insulation sheet 30 in “m” rows (“m” is greater than “M”) by “n” columns (“n” is greater than “N”. Accordingly, it is possible to easily manufacture the sheet type connector having the conductive contacts configured to correspond to the conductive section of the semi-conductor integrated circuit element with which the connector is mated.

Furthermore, the conductive contacts 20 are produced by so-called “successive feeding process” in which the metal sheet 10 is continuously fed for a stamping and forming process. Accordingly, it is possible to improve in precision for shape and pitch of the conductive contacts in order to meet the higher density requirement for the conductive contacts and to provide higher stability in connection for the conductive contacts, and thus, higher reliability in performance for the connector.

FIGS. 6 to 8 shows some examples for usage of the sheet type connector 50. In each figure, “70” represents a semi-conductor integrated circuit element, and “80” conceptually represents a circuit board. In addition, “71” represents a conductive section of the semi-conductor integrated circuit element, and “81” represents a conductive pad on the circuit board 80.

Referring to FIG. 6, a solder ball 90 is provided to the annular conductive portion 21 of the conductive contact 20 exposed to bottom side of the sheet type connector 50. The solder ball 90 is soldered to the conductive pad 81 of the circuit board 80 to mount the sheet type connector 50 onto the circuit board 80. The coiled conductive portion 23 of the conductive contact 20 is resiliently engaged with the conductive section 71 of the semi-conductor integrated circuit element 70 to interconnect between the semi-conductor integrated circuit element 70 and the circuit board 80.

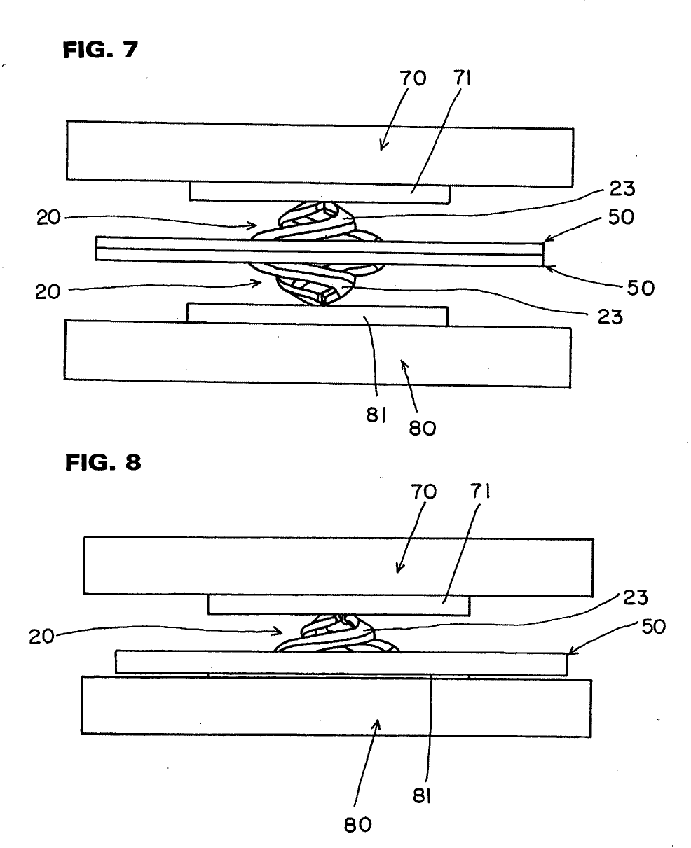

Referring to FIG. 7, a pair of sheet type connectors 50, 50 is adhered to each other. The conductive contacts 20 of the upper and lower sheet type connectors 50 are in conduction with their annular conductive portions 21 engaged to each other. The coiled conductive portion 23 of the conductive contact 20 on the lower sheet type connector 50 is resiliently engaged with the conductive pad 81 of the circuit board 80 to interconnect between the semi-conductor integrated circuit element 70 and the circuit board 80.

Referring to FIG. 8, the sheet type connector 50 is directly mounted to the circuit board 80. The annular conductive portion 21 of the conductive contact 20 is soldered to the conductive pad 81 of the circuit board 80. The semi-conductor integrated circuit element 70 is connected to the circuit board 80 in the same manner as the case of FIGS. 6 and 7.

While the preferred embodiment of the invention have been shown and described, it will be apparent to those skilled in the art that changes and modifications may be made therein without departing from the spirit of the invention, the scope of which is defined by the appended claims.

What is claimed is:

1. A sheet type connector, comprising:
an insulation sheet and a plurality of conductive contacts provided thereon in an array of “M” rows and “N” columns, the contacts being successively stamped and formed in a metal sheet are disposed on a belt-like insulation sheet in an array of “m” rows and “n” columns to produce an intermediate sheet, where “m” is an integer greater than “M” and “n” is an integer greater than “N”, and thereafter, said intermediate sheet is cut into such size that the conductive contacts in “M” rows by “N” columns are included.

2. The connector according to claim 1, in which each said conductive contact includes an outermost annular conductive portion and a coiled conductive portion provided at inner side of the annular conductive portion and projected in an axial direction of the annular conductive portion, and said annular conductive portion is adhered to a bottom surface of the insulation sheet, and said coiled conductive portion is projected upwardly via a through-hole in the insulation sheet.

3. The connector according to claim 1, in which said annular conductive portion has a solder ball provided thereon.

4. The connector according to claim 2, in which said annular conductive portion has a solder ball provided thereon.

5. A method of manufacturing a sheet type connector having an insulation sheet with a plurality of conductive contacts provided thereon in an array of “M” rows and “N” columns, comprising the steps of:
providing a belt-like metal sheet, and successively producing one or more columns of conductive contacts by a stamping and forming process in said metal sheet in the longitudinal direction thereof, said conductive contacts coupled to each other by carriers, said carriers including carriers at one or both sides of the metal sheet, side-carriers, and center carriers;
providing a belt-like insulation sheet having carriers at one or both sides thereof and a plurality “m” of through-holes formed between said carriers at the predetermined interval in the column direction, where “m” is an integer greater than “M”, and separating the stamped and formed conductive contacts in a unit of “m” rows from the metal sheet, and thereafter, adhering that conductive contacts to the insulation sheet while registering the conductive contacts with the through-holes of the insulation sheet, respectively, to form an intermediate sheet;
removing the center carriers each still coupling the conductive contacts adhered to the insulation sheet; and,
cutting the intermediate sheet including the conductive contacts adhered to the insulation sheet into such size that the conductive contacts in “M” rows by “N” columns are included.

6. The method of claim 5, in which said conductive contact includes an outer-most annular conductive portion and a coiled conductive portion provided at inner side of the annular conductive portion and projected in an axial direction of the annular conductive portion, and,
said metal sheet is successively processed by the following processes: a first stamping for external shape of the annular conductive portion; a second stamping for external shape of both the annular conductive portion and the coiled conductive portion;
and a raising of the coiled conductive portion.

7. The method of claim 5, in which said conductive contacts are stamped and formed in the metal sheet in two or more columns, and, said center carrier is provided to diagonally couple four conductive contacts between adjacent columns.

8. The method of claim 5, in which said step of removing the center carriers includes concurrently removing the insulation sheet and the center carrier by a stamping process.

9. The method of claim 5, in which second through-holes are further provided in the insulation sheet between adjacent columns of the through-holes at the position corresponding to the center carriers, and said step of removing the center carriers includes removing them via the second through-holes by a stamping process.

10. The method of claim 5, in which said step of adhering includes adhering the conductive contacts through an adhesive layer provided on a bottom surface of the insulation sheet.

11. The method of claim 5, in which said step of adhering includes adhering the annular conductive portion of the conductive contacts to the adhesive layer provided on a bottom surface of the insulation sheet.

12. The method of claim 5, in which said step of registering includes registering the conductive contacts with the through-holes of said insulation sheet with the aid of pilot holes formed in said carriers of said metal sheet and pilot holes formed in said carriers of said insulation sheet.
